(19) United States
(12) Patent Application Publication
(10) Pub. No.: US 2022/0215412 A1
(43) Pub. Date: Jul. 7, 2022

(54) INFORMATION PROCESSING DEVICE, INFORMATION PROCESSING METHOD, AND PROGRAM

(71) Applicant: Sony Group Corporation, Tokyo (JP)

(72) Inventors: Yuji HORIGUCHI, Tokyo (JP); Shingo TAKAMATSU, Tokyo (JP); Hiroshi IIDA, Tokyo (JP); Kento NAKADA, Tokyo (JP); Masanori MIYAHARA, Tokyo (JP)

(73) Assignee: Sony Group Corporation, Tokyo (JP)

(21) Appl. No.: 17/611,917

(22) PCT Filed: May 1, 2020
(86) PCT No.: PCT/JP2020/018400

§ 371 Date: Nov. 17, 2021

(30) Foreign Application Priority Data
Jun. 12, 2019 (JP) 2019-109461

(51) Int. Cl. G06Q 30/02

(52) U.S. Cl. CPC G06Q 30/0202; G06Q 30/0201

(57) ABSTRACT

An information processing device including: an input unit to which a first data set including a plurality of pieces of data is input; a determination unit that determines processing applied when a prediction model based on a second data set similar to the first data set is generated; and a prediction model generation unit that generates a prediction model based on the first data set by applying the processing determined by the determination unit to the first data set.

### TECHNICAL FIELD

The present disclosure relates to an information processing device, an information processing method, and a program.

### BACKGROUND ART

Conventionally, a technology for predicting various types of information on the basis of past data has been proposed. For example, Patent Document 1 below describes a device that predicts the contract establishment probability for real estate to be traded in a transaction period according to a feature amount of the real estate.

### CITATION LIST

### Patent Document

Patent Document 1: Japanese Patent Application Laid-Open No. 2017-16321

### SUMMARY OF THE INVENTION

### Problems to be Solved by the Invention

In such a field, it is desired that prediction is performed efficiently.

The present disclosure has been made in view of the above-described point, and an object of the present disclosure is to provide an information processing device, an information processing method, and a program that enable efficient prediction.

### Solutions to Problems

The present disclosure provides, for example,

an information processing device including:

an input unit to which a first data set including a plurality of pieces of data is input;

a determination unit that determines processing applied when a prediction model based on a second data set similar to the first data set is generated; and

a prediction model generation unit that generates a prediction model based on the first data set by applying the processing determined by the determination unit to the first data set.

The present disclosure provides, for example,

an information processing method including:

determining, by a determination unit, processing applied when generating a prediction model based on a second data set similar to a first data set including a plurality of pieces of data input to an input unit; and

generating, by a prediction model generation unit, a prediction model based on the first data set by applying the processing determined by the determination unit to the first data set.

The present disclosure provides, for example,

a program for causing a computer to execute an information processing method including:

determining, by a determination unit, processing applied when generating a prediction model based on a second data set similar to a first data set including a plurality of pieces of data input to an input unit; and

generating, by a prediction model generation unit, a prediction model based on the first data set by applying the processing determined by the determination unit to the first data set.

### BRIEF DESCRIPTION OF DRAWINGS

FIG. 1 is a block diagram illustrating a configuration example of an information processing device according to an embodiment.

FIG. 2 is a diagram illustrating an example of tabular data according to the embodiment.

FIG. 3 is a diagram illustrating an example of information stored in a database according to the embodiment.

FIG. 4 is a diagram illustrating an example of parameters applied to predetermined algorithms and values thereof.

FIG. 5 is a diagram illustrating a display example for setting a new project for creating a prediction model.

FIG. 6 is a diagram illustrating a display example for selecting tabular data and causing the information processing device to read the tabular data.

FIG. 7 is a diagram illustrating a display example for setting a feature to be used in processing of generating a prediction model among selected tabular data.

FIG. 8 is a diagram illustrating a display example displayed during tuning of parameters and the like of an algorithm.

FIG. 9 is a diagram for describing a display example of a generated prediction model.

FIG. 10 is a diagram for describing an example of characteristics of each algorithm.

FIG. 11 is a diagram for describing an example of a screen on which a processing item to be prioritized can be set.

FIG. 12 is a diagram illustrating an example of a result of searching an algorithm or the like on the basis of a data set similar to the first data set.

FIG. 13 is a diagram illustrating a display example of asking the user a question about auxiliary information.

FIG. 14 is a diagram illustrating another display example of asking the user a question about auxiliary information.

FIG. 15 is a diagram illustrating another display example of asking the user a question about auxiliary information.

FIG. 16 is a diagram illustrating another display example of asking the user a question about auxiliary information.

FIG. 17 is a diagram illustrating a display example of the usefulness for each feature.

### MODE FOR CARRYING OUT THE INVENTION

Hereinafter, one embodiment and the like of the present disclosure will be described with reference to the drawings. Note that the description will be given in the following order.

### Problems to be Considered in One Embodiment

### 1. One Embodiment

### Modification

The embodiment and the like described below are preferable specific examples of the present disclosure, and the content of the present disclosure is not limited to the embodiment and the like.

### Problems to be Considered in One Embodiment

As described above, a prediction analysis technology for predicting various items (sales, population, traffic congestion, and the like) has been proposed. As the prediction analysis technology becomes generally recognized, there are an increasing number of people who are not experts in statistics and prediction analysis but desire to apply prediction analysis to their data. In order to achieve higher prediction performance in prediction analysis, it is necessary to appropriately select various preprocessing and prediction algorithms and their associated hyperparameters. In order to select the algorithm and the hyperparameter, it is necessary to actually generate and verify the prediction model. However, a large amount of calculation is required to perform many of such steps. Meanwhile, examples of users who actually desire to perform prediction analysis include a sales person who desires to predict sales. However, a case where these users hold a large amount of calculation resources is rare, and it is difficult to obtain a model with high prediction performance by repeatedly attempting generation of a prediction model.

Although a large amount of calculation resources can be acquired by using a cloud service, specialized knowledge is required for prediction analysis using a cloud service. Furthermore, it is necessary to take out data to an external server, and in a case where this is inappropriate from the viewpoint of privacy and security, it is necessary to perform prediction analysis in an environment at hand of the user.

Many methods using Bayesian optimization have been proposed as existing parameter tuning methods, but these methods generally perform optimization by performing several hundred searches for each parameter. In order to simultaneously tune a plurality of parameters and select an algorithm on the basis of these optimization methods in an environment such as a desktop personal computer, it is necessary to search several thousands to several tens of thousands of times, and very long calculation is required. Accordingly, a user having no computer resource for performing these calculations is at a disadvantage.

In order to completely automate generation of a prediction model, it is necessary to perform many searches as described above. An expert in this field generates a prediction model in a short time by narrowing down candidates of a parameter and an algorithm to be searched using an empirical rule. However, since a person who is not an expert does not know how the prior knowledge about his/her own data set corresponds to the parameter of the prediction model, it is difficult to narrow down the search target.

In view of these points, in the following embodiment, there will be described a technology that enables a user who does not have specialized knowledge or advanced computer resources to efficiently perform prediction analysis.

### 1. One Embodiment

### Configuration Example of Information Processing Device

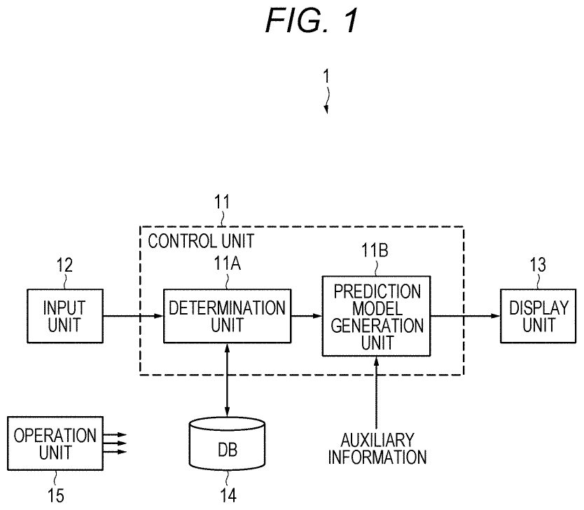

FIG. 1 is a block diagram illustrating a configuration example of an information processing device (information processing device 1) according to one embodiment. Specifically, the information processing device 1 is a personal computer, a tablet computer, a smartphone, a server device on a cloud, or the like.

The information processing device 1 includes, for example, a control unit 11, an input unit 12, a display unit 13, a database (DB) 14, and an operation unit 15. The control unit 11 includes, as functional blocks thereof, a determination unit 11A and a prediction model generation unit 11B.

The control unit 11 has centralized control over the information processing device 1. The control unit 11 includes a central processing unit (CPU) and the like. The control unit 11 includes a read only memory (ROM) that stores a program, a random access memory (RAM) that is used as a work memory when the program is executed, and the like (note that illustration of these configurations is omitted.).

The determination unit 11A determines processing applied when a prediction model based on a second data set similar to a first data set is generated. Such processing is, for example, an algorithm applied when a prediction model based on the second data set is generated and a parameter value in the algorithm (hereinafter appropriately referred to as algorithm and the like in some cases). The prediction model generation unit 11B generates a prediction model based on the first data set by applying processing determined by the determination unit 11A to the first data set. Auxiliary information is input to the prediction model generation unit 11B. Note that details of the operation of the determination unit 11A, the operation of the prediction model generation unit 11B, and the auxiliary information will be described later.

The input unit 12 is an interface to which a first data set including a plurality of data is input. The second data set is also input to the input unit 12. The first data set is a data set input to the input unit 12 on the basis of the current operation. Furthermore, the second data set is a data set input to the input unit 12 in the past. The data set input to the input unit 12 is supplied to the determination unit 11A.

The display unit 13 is a display (including driver that drives display) that displays a prediction model generated by the prediction model generation unit 11B. A liquid crystal display (LCD), an organic light emitting diode (OLED), and the like can be applied as the display unit 13. The display unit 13 may display information with a projector.

The database 14 stores various types of data. Examples of the database 14 include a magnetic storage device such as a hard disk drive (HDD), a semiconductor storage device, an optical storage device, and a magneto-optical storage device. The database 14 may be detachable from the information processing device 1.

The operation unit 15 is a generic term for a configuration that accepts an operation input of a user. Examples of the operation unit 15 include a mouse, a touch panel, and physical keys such as buttons. An operation signal is generated according to an operation input made to the operation unit 15, and processing according to the operation signal is performed.

### Various Types of Data

(Tabular Data, First Data Set, and Second Data Set)

Next, various types of data used in the processing according to the present embodiment will be described. First, tabular data will be described.

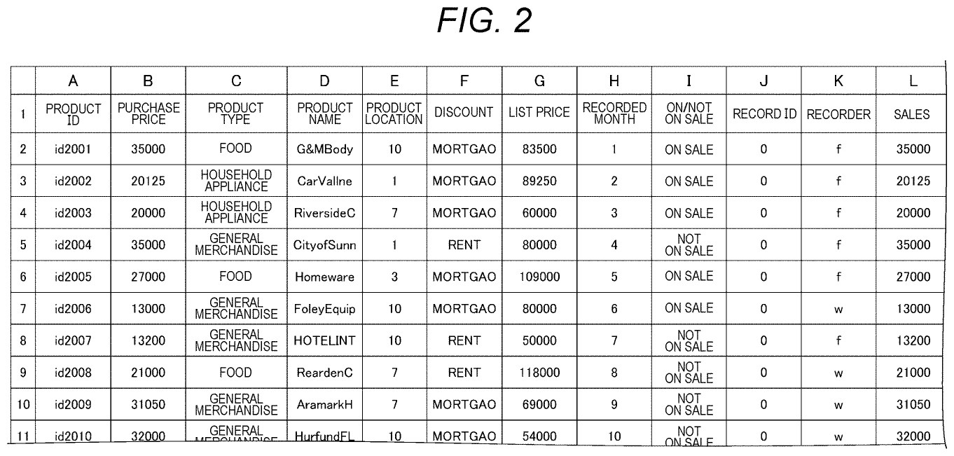

FIG. 2 is a diagram illustrating an example of tabular data. The tabular data may include any content. The example illustrated in FIG. 2 is tabular data of content related to a product sales history. Items (content defined in first row of FIG. 2) indicating the content of data are set as features of various types of data included in the tabular data. The tabular data is designated by the user, for example. The tabular data may be data stored in the information processing device 1 or may be data that the information processing device 1 takes in from an external device.

The first data set is data in which all or some of the features in the tabular data are designated. That is, the first data set in the present embodiment is a data set whose content is set in accordance with a user input to tabular data which is an example of predetermined data. The first data set corresponding to the designated feature is used when the prediction model generation unit 11B generates a prediction model. That is, the first data set may be the entire tabular data or may be a part of the tabular data.

The second data set is a data set similar to the first data set among data sets used when the prediction model generation unit 11B generated a prediction model in the past. Although details will be described later, an index characterizing each of the first data set and the second data set is assigned. By comparing such indices, the second data set similar to the first data set can be determined.

(Information Stored in Database)

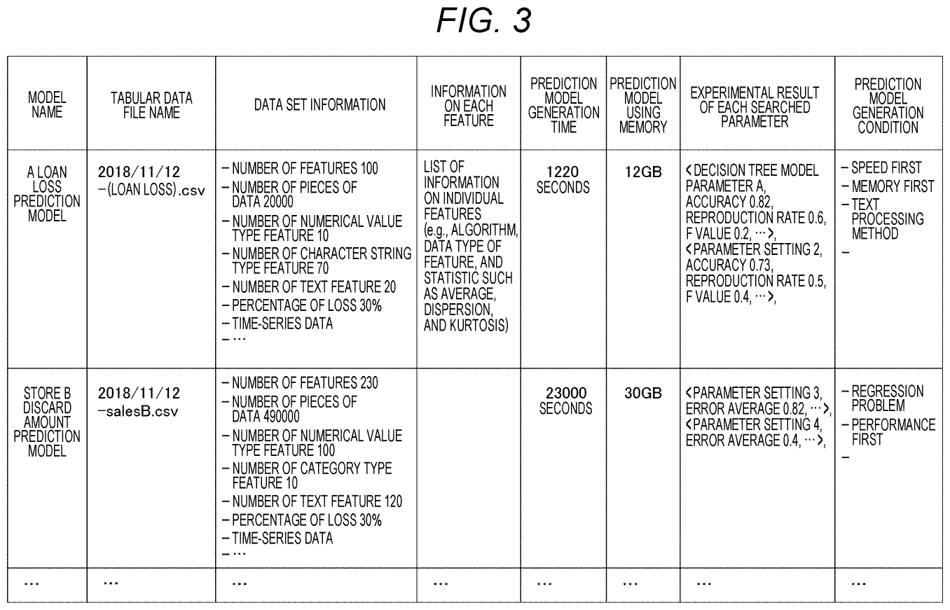

FIG. 3 is a diagram illustrating an example of information (hereinafter appropriately referred to as database information) stored in the database 14. Examples of items set as database information include a model name, a tabular data file name, data set information, information on each feature included in the data set, a prediction model generation time, a prediction model memory usage, an experimental result of each parameter used in the algorithm, and a prediction model generation condition.

The model name is a name set when a prediction model is generated. The model name can be appropriately set according to the content of the prediction model. FIG. 3 illustrates an example in which “A loan loss prediction model” is set as a model name of a certain prediction model, and “store B discard amount prediction model” is set as a model name of another prediction model.

The tabular data file name is tabular data that is the basis of the second data set used when the prediction model is generated and the file name of the tabular data.

The data set information is various types of information regarding the second data set corresponding to the prediction model generated in the past. The data set information is, for example, information indicating the number of pieces of data included in the data set, the number of features, the percentage of lost data, a file size, a domain (information indicating what data is about, such as weather data and sales data), a problem setting (classification, regression, time-series prediction, and the like), and the like.

The information on each feature is information indicating an algorithm applied to a data set when a prediction model is generated, a name of each feature, the number of pieces of unique data, a data type (text, numerical value, date, categorical variable, and the like) of each feature, and statistics (average, dispersion, kurtosis, and the like) for explaining other features. These pieces of information can be quantified (quantified) by a known method. For example, in a case where there is “text data” as the data type of each feature, an identifier indicating “text data” is assigned as the data type. Then, “text data ” is associated with “number of spaces or delimiters”, “average of lengths of sentences”, “type of language”, and the like as examples of statistics. Furthermore, in the case of “timestamp data” indicating a date or the like, an identifier indicating “timestamp data” is assigned as the data type. Then, “average of time zone”, “period included in data”, “format of time stamp data”, and the like are associated as examples of statistics.

The prediction model generation time is the time required to generate the prediction model. The prediction model memory usage is the capacity of a memory required to generate the prediction model.

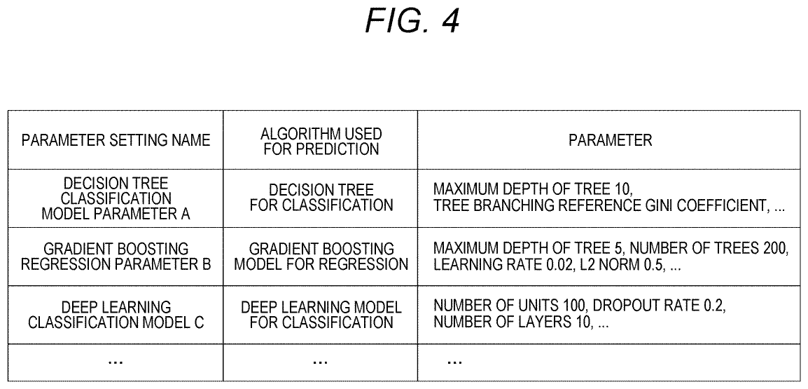

The experimental result of each parameter used in the algorithm is information indicating the history of the parameter of the applied algorithm and the result when the prediction model is generated with the parameter. The set parameter name is entered in this item. As illustrated in FIG. 4, the set parameter name is associated with the name of an algorithm used for predicting the prediction model and a specific parameter value. Note that there is a case where a prediction model is generated by changing the algorithm, and a case where a prediction model is generated by changing the parameter value of the same algorithm. All of such cases are entered as history.

FIG. 3 illustrates that, for example, when a prediction model of a model name “A loan loss prediction model” is generated, “decision tree for classification” is used as the algorithm, and parameters corresponding to “decision tree model parameter A” and values thereof are used as the parameter. Further, FIG. 3 illustrates that, as a result of generating the prediction model using the parameters and the values of the parameters, the accuracy is “0.82”, the reproduction rate is “0.6”, and the F value is “0.2”.

The prediction model generation condition is a condition indicating the processing item to be prioritized when the prediction model is generated. Such processing item is set by a user's operation input. The processing item is, for example, any of “performance first”, “speed first”, and “memory first”. “Performance first” is a setting that prioritizes accuracy of the prediction model. “Speed first” is a setting that prioritizes the speed at which the prediction model is generated. “Memory first” is a setting that prioritizes a setting in which the capacity of the memory used when the prediction model is generated is as small as possible.

The prediction memory generation condition includes the content of auxiliary information answered by the user. The auxiliary information is information for efficiently generating a prediction model on the basis of the first data set. Specifically, the auxiliary information is at least one of a period of data to be used for generation of a prediction model among time-series data included in the first data set, designation of text data to be used for generation of a prediction model among text data included in the first data set, or information regarding accuracy of predetermined data included in the first data set. The information processing device 1 acquires the auxiliary information on the basis of a user's answer input to a question made by the information processing device 1 to the user.

The above is an example of the database information. Note that the above-described distinction among items of the database information is for convenience and can be changed as appropriate.

### Operation Example of Information Processing Device

### Operation Example A1

Subsequently, a plurality of operation examples of the information processing device 1 will be described. First, Operation Example A1 of the information processing device 1 will be described. Note that unless otherwise specified, the operation (including other operation examples) of the information processing device 1 described below is performed under the control of the control unit 11.

“Procedure B1”

First, the user starts a project for generating a prediction model using the operation unit 15 of the information processing device 1, and selects tabular data to be used for generation of the prediction model and causes the information processing device 1 to read the tabular data. Then, the user designates a feature in the tabular data to be used for the processing of generating the prediction model. With such designation, a first data set based on the read tabular data is generated. Such processing is appropriately referred to as “Procedure B1” in the following description.

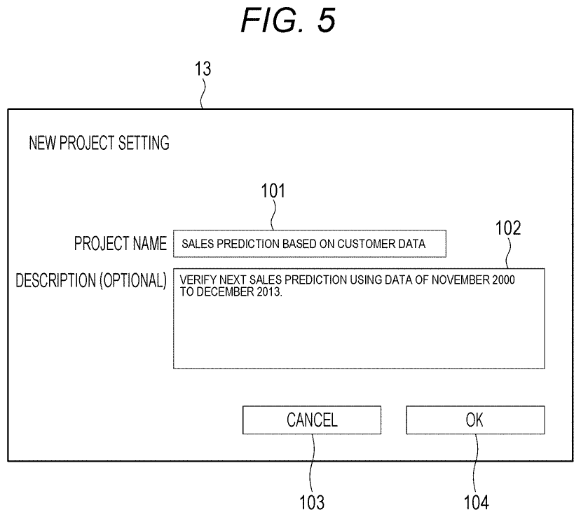

FIG. 5 is a diagram illustrating a display example for setting a new project for generating a prediction model. The display example illustrated in FIG. 5 is displayed on the display unit 13 of the information processing device 1, for example. The display unit 13 displays a rectangular display frame 101 to which a project name can be input, a rectangular display frame 102 to which an appropriate description or memo can be input, a cancel button 103, and an OK button 104. The user inputs information to each display part using the operation unit 15.

Specifically, the user inputs an appropriate project name (“Sales prediction based on customer data” in illustrated example) into the display frame 101. Furthermore, the user inputs an appropriate description (“Verify next sales prediction using data of November 2000 to December 2013” in illustrated example) into the display frame 102 as necessary, using the operation unit 15.

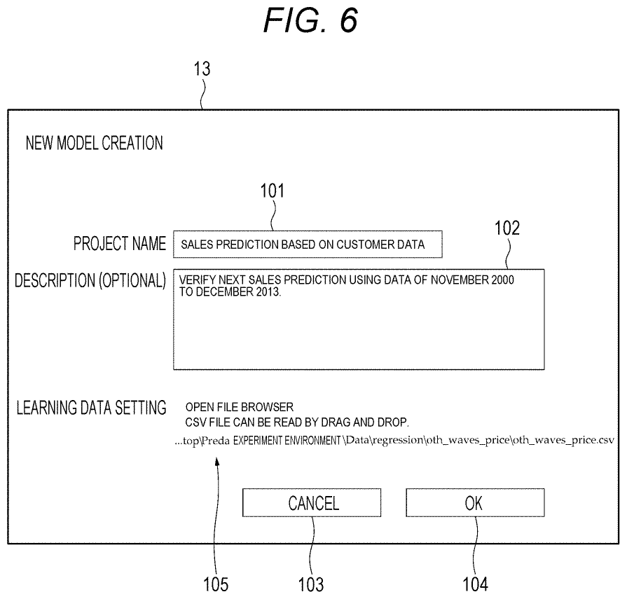

FIG. 6 is a diagram illustrating a display example for selecting tabular data and causing the information processing device 1 to read the tabular data. The user selects tabular data using the operation unit 15. Address information 105 of the storage location of the selected tabular data is displayed on the display unit 13. To end the input of the project name, the input of the description accompanying the project name, and the selection of the tabular data performed so far, the user clicks the OK button 104. To correct the project name, for example, the user clicks the cancel button 103 to perform the input again.

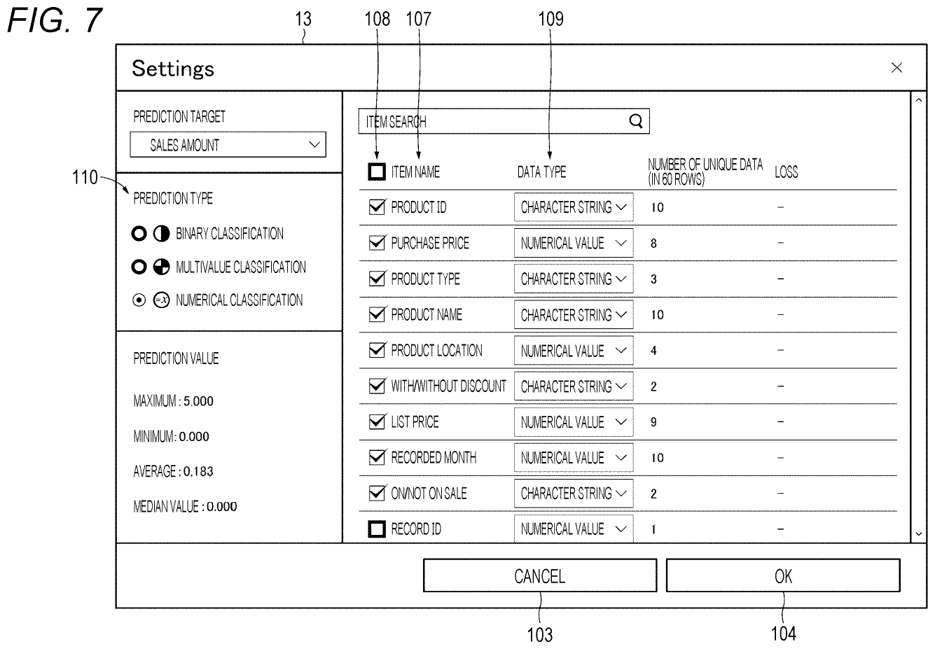

When the OK button 104 is pressed, the display content of the display unit 13 transitions to the display content illustrated in FIG. 7. FIG. 7 is a diagram illustrating a screen example for setting a feature (item in tabular data in present example) to be used in the processing of generating the prediction model among the selected tabular data. As illustrated in FIG. 7, item names 107, which are names of items in the tabular data, are displayed on the display unit 13. A check box 108 is displayed on the left side of each item. For example, the user checks a check box corresponding to a feature used to generate the prediction model, and unchecks a check box corresponding to a feature not used to generate the prediction model. Note that at least one check box may be checked, or all the check boxes may be checked. Furthermore, in FIG. 7, a data format 109 can be set for each feature. Furthermore, it is also possible to set a prediction type 110 (output format such as binary classification, multi-value classification, and numerical classification) that is a result of the prediction model, using the screen illustrated in FIG. 7.

To end the settings related to each feature, the OK button 104 is clicked by the user. As a result, creation of the first data set based on the tabular data is completed.

“Procedure B2”

When creation of the first data set is completed, calculation for obtaining “data set information” and “information on each feature” (see FIG. 2) is performed on the first data set. The determination unit 11A searches for and determines a second data set similar to the first data set from among the plurality of second data sets stored in the database 14 on the basis of the calculation result. For example, the determination unit 11A determines, as the second data set similar to the first data set, a data set in which the data set information is the same as that of the first data set or a value obtained by integrating difference values between the pieces of information of the first data set and the second data set is equal to or less than a certain value. Furthermore, the determination unit 11A may refer to the information on each feature and determine that a data set having many similar features as a second data set similar to the first data set, or may determine the second data set similar to the first data set by a method combining the above. In the present example, one second data set is determined by the determination unit 11A as a data set similar to the first data set.

“Procedure B3”

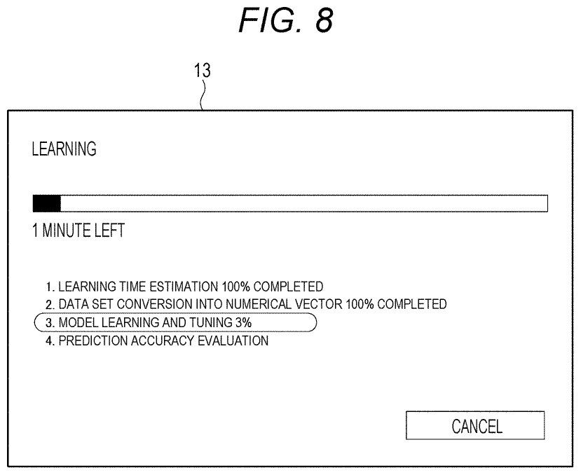

In Procedure 3, an algorithm or the like applied to the second data set determined in Procedure B2 is determined by the determination unit 11A. The determination unit 11A refers to the database information to acquire an algorithm or the like applied to the second data set. Then, various settings are tuned to match the algorithm or the like applied to the second data set. An example of a screen displayed during the tuning is illustrated in FIG. 8.

“Procedure B4”

When tuning related to various settings is completed in Procedure B3, the prediction model generation unit 11B generates a prediction model by applying the tuned algorithm or the like to the first data set. Then, the generated prediction model is displayed on the display unit 13.

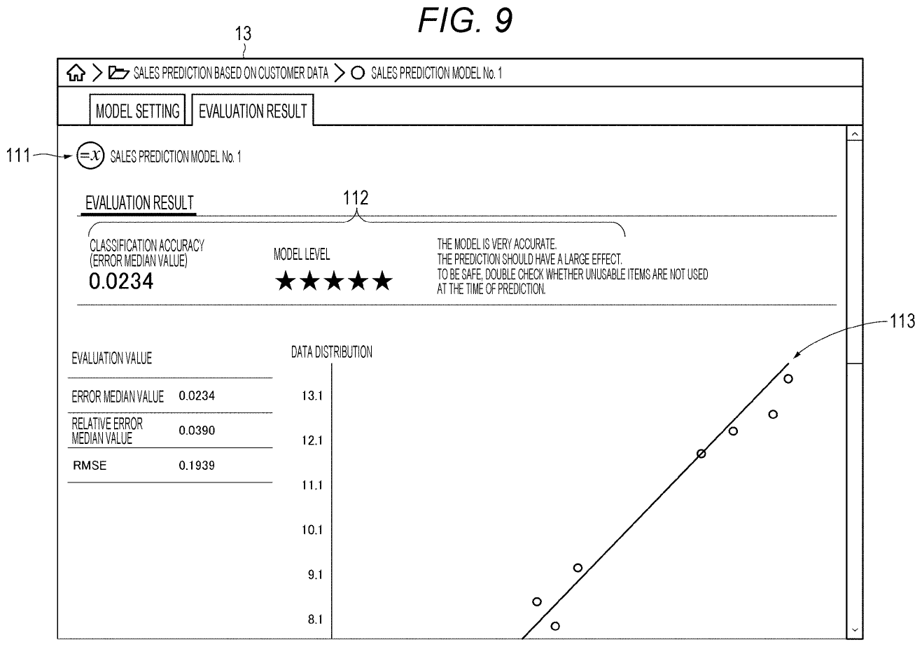

FIG. 9 is a diagram illustrating a display example of the generated prediction model. A graph 113 indicating a sales prediction is displayed on the display unit 13. Furthermore, information 111 (numerical classification in illustrated example) of the prediction type set by the user is displayed. Furthermore, information 112 regarding the accuracy of the prediction model is displayed. Note that the content of the processing of generating the prediction model (algorithm or the like, accuracy of prediction model, and the like) is stored in the database 14 as new database information.

The content of the processing performed in Operation Example A1 of the information processing device 1 has been described above. As described above, the second data set similar to the first data set set when the prediction model is generated is searched, and the algorithm or the like applied to the searched second data set is applied to the first data set. As a result, there is no need to search for an effective algorithm or the like from scratch when generating a prediction model based on the first data set. Accordingly, a prediction model based on the first data set can be generated efficiently. Furthermore, since the user only needs to set the first data set on the basis of the tabular data, it is possible to generate a desired prediction model even for a user who does not have specialized knowledge or skill.

Note that in Procedure B2, a plurality of second data sets similar to the first data set may be determined. For example, a plurality of second data sets having a certain degree of similarity or more with the first data set may be determined by the determination unit 11A. For example, assume that 100 second data sets having a certain degree of similarity or more with the first data set are searched. An algorithm or the like applied to the largest number of second data sets among the searched second data sets may be applied in Procedure B4. Furthermore, about 10 second data sets having a certain degree or more of similarity with the first data set may be searched, and an algorithm or the like applied to each data set may be sequentially applied to the first data set. Then, as a result, the generated prediction models (10 prediction models) may be sequentially displayed on the display unit 13.

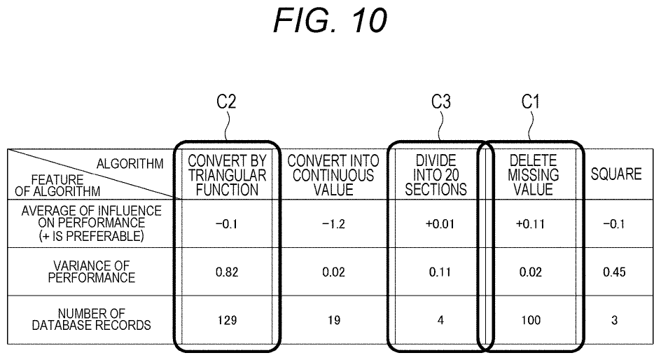

Furthermore, verification may be performed by applying a plurality of algorithms or the like to the first data set according to a predetermined standard. For example, as illustrated in FIG. 10, features (e.g., average of influence on performance, variance of performance, number of database records (number of algorithm applications), and the like) for each algorithm may be recorded in the database 14. For example, in a case where a criterion for preferentially verifying an algorithm that is on average positive is set, the performance of a part surrounded by reference symbol C1 is the largest in the positive direction, and thus, verification that prioritizes the algorithm corresponding to the reference symbol C1 (delete missing value) is performed. Furthermore, for example, in a case where a criterion for preferentially verifying an algorithm having a large variance is set, since the variance of a part surrounded by reference symbol C2 is the largest, verification that prioritizes the algorithm corresponding to the reference symbol C2 (convert by triangular function) is performed. Furthermore, for example, in a case where a criterion of upper confidence bound (small number of searches, and no certainty that performance will be positive) is set, since the number of database records, which is the number of applications of the algorithm whose performance is positive, of a part surrounded by reference symbol C3 is the smallest, verification that prioritizes the algorithm corresponding to the reference symbol C3 (divide into 20 sections) is performed. The content of the reference may be determined in advance or may be set by the user.

### Operation Example A2

Subsequently, Operation Example A2 will be described. Note that processing and display examples that are the same as or similar to the processing and display examples described in Operation Example A1 are denoted by the same reference symbols, and redundant description will be omitted as appropriate. Operation Example A2 is an operation in which an algorithm or the like is selected on the basis of a processing item (e.g., “speed first”, “performance first”, and the like) to be prioritized set by the user, and a prediction model is generated on the basis of the selected algorithm or the like.

“Procedure B21”

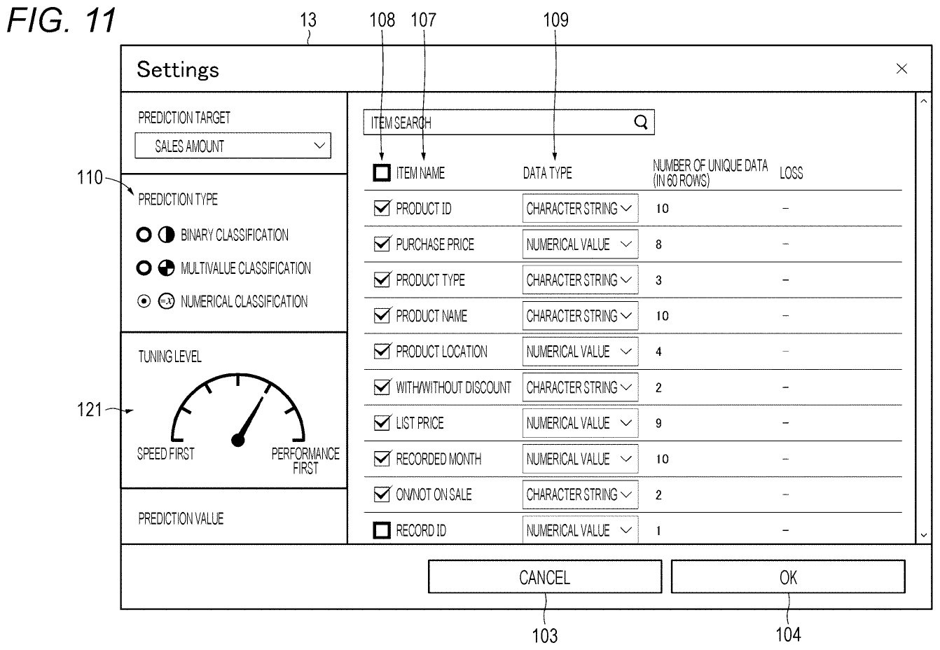

In Procedure B21, processing basically similar to that in Procedure B1 is performed. Procedure B21 is different from Procedure B1 in that a processing item to be prioritized can also be set. FIG. 11 is a diagram illustrating an example of a screen on which a processing item to be prioritized can be set. In the display example illustrated in FIG. 11, in addition to the content of the screen illustrated in FIG. 7, a processing item setting display 121 capable of setting a processing item to be prioritized is displayed.

The processing item setting display 121 is displayed by, for example, a semicircular indicator. The left end of the indicator corresponds to speed first, and the right side of the indicator corresponds to performance first. By setting the needle of the indicator at an appropriate position, it is possible to set how much priority can be given to the speed or the performance. As a specific example, in a case where the needle of the indicator in the processing item setting display 121 is set at the left end, a processing item with the content “completely speed first” is set. Furthermore, in a case where the needle of the indicator is set between the center and the left end, a processing item with the content “slightly speed first” is set. Furthermore, in a case where the needle of the indicator in the processing item setting display 121 is set at the right end, a processing item with the content “completely performance first” is set. In a case where the needle of the indicator in the processing item setting display 121 is set between the center and the right end, a processing item with the content “slightly performance first” is set.

“Procedure B22”

In Procedure B22, processing basically similar to that in Procedure B2 and Procedure B3 is performed. Overall, data sets similar to the first data set are selected. Then, data sets corresponding to the processing item to be prioritized set by the user are further selected from the selected data sets, and the selected data sets are set as the second data set.

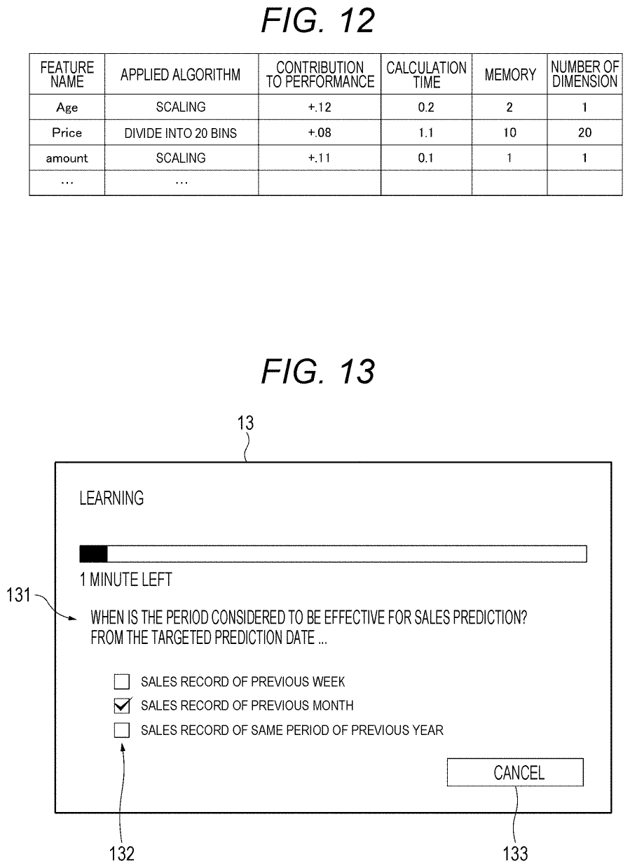

In a case where “completely speed first” is set in the processing item setting display 121, for example, data sets in the top 1% of speed with shorter processing time (prediction model generation time in FIG. 3) are selected from the data sets similar to the first data set, and the selected data sets are set as the second data set. Then, for example, an algorithm or the like most used in the set second data sets is set as the algorithm or the like applied to the first data set. All of the algorithms or the like applied to the set second data sets may be applied to the first data set to perform verification. In a case where “slightly speed first” or “slightly performance first” is set in the processing item setting display 121, for example, data sets in the top 10% of speed and in the top 10% of performance (accuracy in FIG. 3) are selected from data sets similar to the first data set, and the selected data sets are set as the second data set. Then, an algorithm or the like most used in the set second data sets is set as the algorithm or the like applied to the first data set. In a case where “completely performance first” is set in the processing item setting display 121, data sets in the top 1% having high performance are selected from the data sets similar to the first data set, and the selected data sets are set as the second data set. Then, an algorithm or the like most used in the set second data sets is set as the algorithm or the like applied to the first data set. FIG. 12 is a diagram illustrating an example of a result of searching an algorithm or the like on the basis of a data set similar to the first data set.

“Procedure B23”

In Procedure B23, processing similar to that in Procedure B3 is performed. Overall, the prediction model generation unit 11B generates a prediction model by applying the tuned algorithm or the like to the first data set. Then, the generated prediction model is displayed on the display unit 13.

According to the present example, the prediction model can be generated on the basis of the processing item to be prioritized set by the user. Note that settings related to memory first or the like may be set in addition to speed first and performance first, and the display mode of the processing item setting display 121 can be appropriately changed according to the content and number of the processing items to be prioritized.

### Operation Example A3

Subsequently, Operation Example A3 will be described. Note that processing and display examples that are the same as or similar to the processing and display examples described in Operation Examples A1 and A2 are denoted by the same reference symbols, and redundant description will be omitted as appropriate.

In the present example, an example is assumed in which the information processing device 1 is used to generate a prediction model that predicts sales for the following week from user data for each hour of a certain store. Normally, when performing sales prediction at a certain point of time, it is often effective to perform prediction on the basis of information such as “cumulative sales in the previous x weeks” or “sales in the same period of last year”. However, it is inefficient to verify all of the periods, such as “one week ago”, “two weeks ago”, . . . “one year ago”, and so on to determine which is effective. Against this background, in the present example, a dialog for asking the user a question about information (which period of accumulated data has an effect on prediction if added to feature, in the case of present example) that cannot be narrowed down from the past database information is displayed, and auxiliary information as a hint necessary for processing is received from the user. A prediction model is generated by applying processing based on the auxiliary information to the first data set.

“Procedure B31”

In Procedure B31, processing similar to that in Procedure B1 and Procedure B2 is performed.

“Procedure B32”

In Procedure B32, a notification for asking the user about auxiliary information is made. FIG. 13 is a diagram illustrating a display example of asking the user a question about auxiliary information. On the display unit 13, for example, a question 131 “When is the period considered to be effective for sales prediction?” is displayed. Furthermore, answer candidates 132 to the question is displayed on the display unit 13. Furthermore, a cancel button 133 for canceling the answer content is displayed on the display unit 13. In the illustrated example, three answer candidates 132 are displayed. Note that even while the user is answering the question, in the background, the period of sales is appropriately changed and tuning of the parameters of the prediction model is continued.

“Procedure B33”

Assume that the prediction model generation unit 11B obtains, in response to the question, auxiliary information of the user's answer that “the cumulative sales in the previous month of the desired prediction timing” is effective for sales prediction. The prediction model generation unit 11B applies processing based on the auxiliary information. For example, a feature “previous month” is added to a feature (e.g., sales) of the first data set. As a result, data of all sales is narrowed down to data of the previous month. Note that a data set similar to the first data set may be searched again on the basis of the added feature, and the second data set may be reset on the basis of the search result.

“Procedure B34”

In Procedure B34, processing similar to that in Procedure B4 is performed. A prediction model is generated by applying a predetermined algorithm or the like to the first data set to which the feature is added by the prediction model generation unit 11B. The generated prediction model is displayed.

According to the present example, it is possible to obtain auxiliary information that is effective for prediction analysis or is information for efficiently performing prediction analysis. Hence, it is possible to perform prediction analysis more efficiently.

### Operation Example A4

Subsequently, Operation Example A4 will be described. Note that processing and display examples that are the same as or similar to the processing and display examples described in Operation Examples A1 to A3 are denoted by the same reference symbols, and redundant description will be omitted as appropriate. In the present example, the content of auxiliary information is different from that of above-described Operation Example A3.

In the present example, as a specific example, an example of predicting the satisfaction level of the user from a sentence of a product review is assumed. Accordingly, the first data set includes at least text data. In the case of text data, for example, it is conceivable to perform preprocessing of excluding words (e.g., “desu”, “masu”, and the like) not necessary for prediction from data. Such processing can also be performed automatically by observing the degree of contribution to prediction while repeatedly generating a prediction model. However, the processing is not efficient because it takes a very long time. In such a case, by receiving the auxiliary information as a hint from the user, the information processing device 1 can reduce the time for performing these verifications.

“Procedure B41”

In Procedure B41, the same processing as that in Procedure B1 and Procedure B2 is performed.

“Procedure B42”

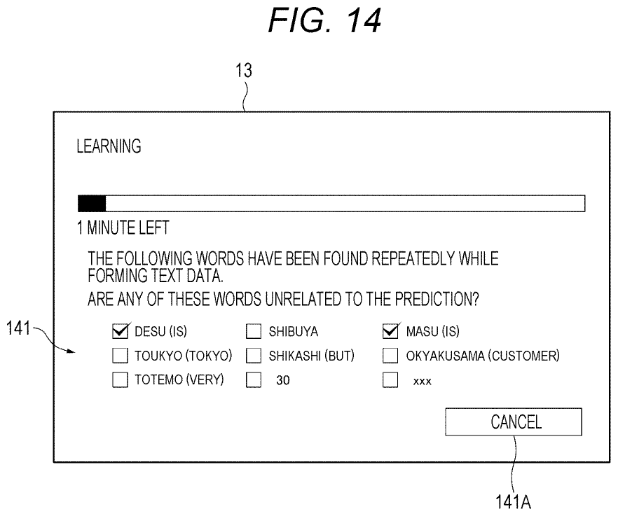

In Procedure B42, the display unit 13 displays a question about auxiliary information. For example, as illustrated in FIG. 14, a plurality of words (word group 141) included in the first data set and retrieved a certain number of times or more is displayed on the display unit 13. A check box is displayed for each word of the word group 141, and, for example, by checking a word unnecessary for prediction, the word is set as a word unnecessary for prediction analysis. For example, in the example illustrated in FIG. 14, the words “desu (is)” and “masu (is)” are set as words unnecessary for prediction. Furthermore, a cancel button 141A for canceling the setting content is displayed on the display unit 13.

“Procedure B43”

In Procedure B43, processing similar to that in Procedure B4 is performed. Furthermore, when the prediction model generation unit 11B generates a prediction model, processing based on the auxiliary information is applied. Specifically, the prediction model is generated by applying a predetermined algorithm or the like to the first data set in which “desu” and “masu” are excluded from the text data. The generated prediction model is displayed.

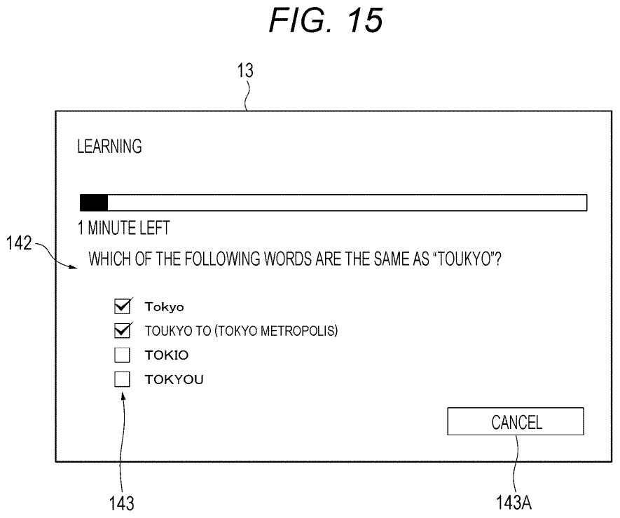

Note that the auxiliary information is not limited to the above-described information regarding a period of data or a word unnecessary for prediction. The auxiliary information may be, for example, information that names words that refer to the same object but are treated as different words due to notation variation. FIG. 15 is a diagram illustrating a display example of asking the user a question about such auxiliary information. In the example illustrated in FIG. 15, a question 142 “Which of the following words are the same as “Tokyo”?” is displayed as a question for obtaining the auxiliary information. Then, for example, a word group 143 including four words (“Tokyo”, “Toukyo to (Tokyo metropolis)”, “TOKIO”, “TOKYOU”) is displayed below the question 142. A check box is displayed next to each word of the word group 143. Furthermore, a cancel button 143A for canceling the setting content is displayed on the display unit 13. For example, the user checks words that are the same as “Tokyo”. Then, when generating the prediction model, the prediction model generation unit 11B generates the prediction model so that the words “Tokyo” and “Toukyo to” are treated as the same words as “Tokyo”.

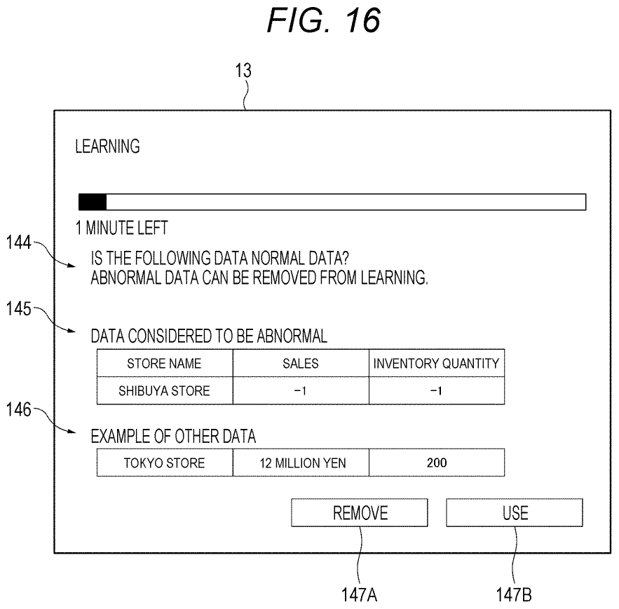

The auxiliary information may be information in which whether or not it is an outlier, in other words, the accuracy of the data included in the first data set is confirmed by the user. For example, sales and inventory quantities are usually positive values. However, in a case where there is a negative value in the feature of the first data set, specifically, data corresponding to the sales or the inventory quantity, there is a high possibility that the data is abnormal data. On the other hand, if the processing of verifying whether the data is abnormal is performed, the prediction analysis becomes inefficient. For this reason, the user is asked to confirm whether or not data different from other data is abnormal data. FIG. 16 is a diagram illustrating a display example of asking the user a question about such auxiliary information. In the example illustrated in FIG. 16, for example, a question 144 “Is the following data normal data?” is displayed. Then, content 145 (“store name: Shibuya store, sales: −1, inventory quantity: −1” in illustrated example) of specific data that is considered to be abnormal is displayed. Furthermore, in FIG. 16, content 146 (“store name: Tokyo store, sales: 12 million yen, inventory quantity: 200” in illustrated example) of other data that is considered to be normal is displayed, so that the user can compare the data considered to be normal with the data considered to be abnormal. In a case where the displayed data is abnormal, the user inputs the auxiliary information by clicking a button 147A displayed as “remove”. In this case, data related to sales and inventory quantity of the Shibuya store is excluded from the first data set used when the prediction model is generated. In a case where the displayed data is used for the processing of generating the prediction model, the user inputs the auxiliary information by clicking a button 147B displayed as “use”. In this case, the data regarding sales and inventory quantity of the Shibuya store is used without being excluded from the first data set used when the prediction model is generated.

According to the present example, it is possible to obtain auxiliary information that is effective for prediction analysis or is information for efficiently performing prediction analysis. Hence, it is possible to perform prediction analysis more efficiently.

### Operation Example A5

The present example is an example of requesting a hint from the user who has confirmed the result of generating the prediction model. Specifically, in a case where the information processing device 1 generates a prediction model by performing demand prediction on the basis of sales data manually input, but performance of the prediction model is not very good, processing of accepting feedback from the user is assumed. Then, the algorithm or the like is reset on the basis of the feedback.

“Procedure B51”

In Procedure B51, Procedures B1 to B4 are performed to generate a prediction model. Then, in Procedure B51, the information processing device 1 determines the usefulness indicating how useful each feature set to be used for prediction analysis by the user at the time of generating the prediction model based on the first data set. For example, the control unit 11 of the information processing device 1 determines the usefulness of each feature on the basis of how much data corresponding to the feature has been used in the calculation for generating the prediction model. The usefulness of each feature may be determined by another known method, as a matter of course.

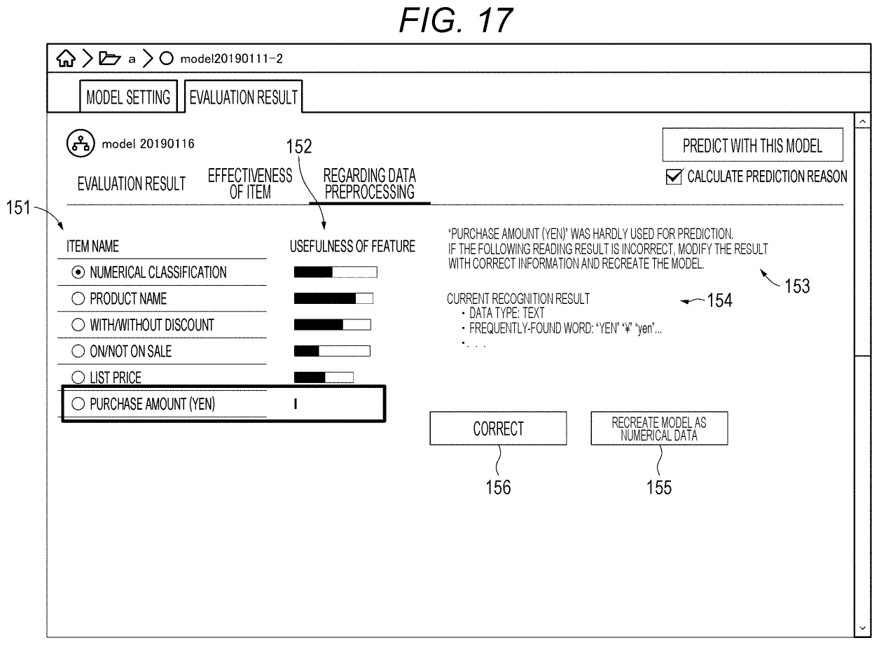

The determined usefulness of each feature is displayed on the display unit 13. FIG. 17 is a diagram illustrating a display example of the usefulness for each feature. Item names 151, which are features, are displayed, and usefulness 152 is displayed on the right side of each item name. The usefulness 152 is displayed as, for example, a rectangular frame, and it is indicated that the greater the black part in the frame, the higher the usefulness 152. The display mode of the usefulness 152 can be appropriately changed, as a matter of course. For example, the usefulness 152 may be displayed by a specific score. Furthermore, on the display unit 13, a comment 153 regarding a feature whose usefulness is equal to or less than a predetermined value is displayed. In the example illustrated in FIG. 17, the usefulness regarding “purchase amount” which is one of the features is remarkably low. Hence, as the comment 153, for example, a comment of the content “Purchase amount (yen)” was hardly used for prediction” is displayed. Furthermore, the display unit 13 displays a current recognition result 154 regarding “purchase amount (yen)” that is a feature having low usefulness.

“Procedure B52”

In Procedure B52, the user checks the displayed usefulness 152. On the basis of the usefulness 152, the user recognizes that the data of “purchase amount (yen)” assumed to be related to sales is not useful in generating the prediction model (usefulness is low). Furthermore, on the basis of the recognition result 154, the user recognizes that since symbols such as comma, circle, and ¥ are mixed in “purchase amount (yen)”, “purchase amount (yen)” is processed as a character string, not as numerical data. The user sets the data format of “purchase amount (yen)” to numerical data on the basis of such recognition (see FIG. 7). Then, the user clicks a button 155.

“Procedure B53”

When the button 155 is clicked, “purchase amount (yen)” is treated as numerical data, and then the processing of above-described Procedures B2 to B4 is performed. Then, the prediction model by the prediction model generation unit 11B is generated again, and the generated prediction model is displayed on the display unit 13.

Note that in Procedure B52, there may be a case where it is not necessary to correct the prediction model even when the usefulness 152 is low. In such a case, the user simply clicks a “correct” button 156 displayed on the display unit 13.

According to the present example, the user can easily notice a setting mistake in generating the prediction model. Then, by feedback from the user, an accurate prediction model can be generated.

According to the present embodiment described above, it is possible to generate a prediction model having high performance in a short time on a tool that repeatedly generates prediction models or in an environment in which the performance of a prediction model is verified repeatedly using similar data sets. Furthermore, it is possible to generate a prediction model in a shorter time by the user answering a question while searching for an algorithm or the like. Furthermore, it is possible to generate a prediction model according to settings such as performance first and speed first set by the user at a higher speed using a history of an algorithm or the like applied in the past.

### Modification

While one embodiment of the present disclosure has been specifically described above, the content of the present disclosure is not limited to the above-described embodiment, and various modifications based on the technical idea of the present disclosure are possible. Hereinafter, modifications will be described.

In the embodiment described above, the content of the first data set may be set by designating a specific value or range regarding the generation time of the prediction model, the limitation of the memory capacity used in generating the prediction model, the generation time of the prediction model, and the like by the user. Furthermore, while various settings and generated prediction models are notified by display in the above-described embodiment, the various settings and generated prediction models may be notified by voice or the like. The tabular data may be data input by the user.

A part of the processing performed by the information processing device 1 may be performed by a device on a cloud or an external device such as a smartphone. Furthermore, the content of the operation examples in the above-described embodiments can be appropriately combined.

The configuration of the information processing device 1 according to the embodiment can be changed as appropriate. For example, the information processing device 1 may include a communication unit for communicating with a server device or the like, a speaker for reproducing sound, or the like.

The present disclosure can also be implemented by an apparatus, a method, a program, a system, and the like. For example, a program that performs the function described in the above-described embodiment can be provided in a downloadable state, and a device that does not have the function described in the embodiment can download and install the program to control the device in the manner described in the embodiment. The present disclosure can also be implemented by a server that distributes such a program. Furthermore, the items described in each of the embodiments and modifications can be appropriately combined.

Note that the content of the present disclosure should not be interpreted as being limited by the exemplified effects.

The present disclosure can also adopt the following configurations.

(1)

An information processing device including:

an input unit to which a first data set including a plurality of pieces of data is input;

a determination unit that determines processing applied when a prediction model based on a second data set similar to the first data set is generated; and

a prediction model generation unit that generates a prediction model based on the first data set by applying the processing determined by the determination unit to the first data set.

(2)

The information processing device according to (1), in which

the determination unit determines an algorithm applied when a prediction model based on the second data set is generated and a parameter value in the algorithm.

(3)

The information processing device according to (1) or (2), in which

content of the first data set is set according to a user input for predetermined data.

(4)

The information processing device according to (3), in which

content of the first data set is set by setting, according to a user input, at least one of a feature of data to be included in the first data set, a value of a prediction model generated by the prediction model generation unit, a time required for generating a prediction model by the prediction model generation unit, or a memory capacity required for generating a prediction model by the prediction model generation unit.

(5)

The information processing device according to (4), in which

for each of the features of data to be included in the first data set set according to the user input, a notification is made for a usefulness of the feature in generating a prediction model based on the first data set.

(6)

The information processing device according to any one of (1) to (5), in which

a processing item to be prioritized when a prediction model is generated by the prediction model generation unit can be set.

(7)

The information processing device according to (6), in which

the determination unit determines processing applied when a prediction model based on the second data set similar to the first data set and corresponding to the set processing item is generated.

(8)

The information processing device according to any one of (1) to (7), in which

a user is notified of a question about auxiliary information for generating the prediction model.

(9)

The information processing device according to (8), in which

the auxiliary information is at least one of a period of data to be used for generation of the prediction model among time-series data included in the first data set, designation of text data to be used for generation of the prediction model among text data included in the first data set, or information regarding accuracy of predetermined data included in the first data set.

(10)

The information processing device according to (7) or (8), in which

the prediction model generation unit generates a prediction model based on the first data set by applying the processing determined by the determination unit and the processing based on the auxiliary information obtained from a response of the user.

(11)

The information processing device according to any one of (1) to (10), in which

the first data set is a data set currently input to the input unit, and the second data set is a data set previously input to the input unit.

(12)

An information processing method including:

determining, by a determination unit, processing applied when generating a prediction model based on a second data set similar to a first data set including a plurality of pieces of data input to an input unit; and

generating, by a prediction model generation unit, a prediction model based on the first data set by applying the processing determined by the determination unit to the first data set.

(13)

A program for causing a computer to execute an information processing method including:

determining, by a determination unit, processing applied when generating a prediction model based on a second data set similar to a first data set including a plurality of pieces of data input to an input unit; and

generating, by a prediction model generation unit, a prediction model based on the first data set by applying the processing determined by the determination unit to the first data set.

### REFERENCE SIGNS LIST

1 Information processing device

11 Control unit

11A Determination unit

11B Prediction model generation unit

12 Input unit

1. An information processing device comprising:
an input unit to which a first data set including a plurality of pieces of data is input;
a determination unit that determines processing applied when a prediction model based on a second data set similar to the first data set is generated; and
a prediction model generation unit that generates a prediction model based on the first data set by applying the processing determined by the determination unit to the first data set.

2. The information processing device according to claim 1, wherein
the determination unit determines an algorithm applied when a prediction model based on the second data set is generated and a parameter value in the algorithm.

3. The information processing device according to claim 1, wherein
content of the first data set is set according to a user input for predetermined data.

4. The information processing device according to claim 3, wherein
content of the first data set is set by setting, according to a user input, at least one of a feature of data to be included in the first data set, a value of a prediction model generated by the prediction model generation unit, a time required for generating a prediction model by the prediction model generation unit, or a memory capacity required for generating a prediction model by the prediction model generation unit.

5. The information processing device according to claim 4, wherein
for each of the features of data to be included in the first data set set according to the user input, a notification is made for a usefulness of the feature in generating a prediction model based on the first data set.

6. The information processing device according to claim 1, wherein
a processing item to be prioritized when a prediction model is generated by the prediction model generation unit can be set.

7. The information processing device according to claim 6, wherein
the determination unit determines processing applied when a prediction model based on the second data set similar to the first data set and corresponding to the set processing item is generated.

8. The information processing device according to claim 1, wherein
a user is notified of a question about auxiliary information for generating the prediction model.

9. The information processing device according to claim 8, wherein
the auxiliary information is at least one of a period of data to be used for generation of the prediction model among time-series data included in the first data set, designation of text data to be used for generation of the prediction model among text data included in the first data set, or information regarding accuracy of predetermined data included in the first data set. cm 10. The information processing device according to claim 7, wherein
the prediction model generation unit generates a prediction model based on the first data set by applying the processing determined by the determination unit and the processing based on the auxiliary information obtained from a response of the user.

11. The information processing device according to claim 1, wherein
the first data set is a data set currently input to the input unit, and the second data set is a data set previously input to the input unit.

12. An information processing method comprising:
determining, by a determination unit, processing applied when generating a prediction model based on a second data set similar to a first data set including a plurality of pieces of data input to an input unit; and
generating, by a prediction model generation unit, a prediction model based on the first data set by applying the processing determined by the determination unit to the first data set.

13. A program for causing a computer to execute an information processing method comprising:
determining, by a determination unit, processing applied when generating a prediction model based on a second data set similar to a first data set including a plurality of pieces of data input to an input unit; and
generating, by a prediction model generation unit, a prediction model based on the first data set by applying the processing determined by the determination unit to the first data set.
